(19) United States
(12) Patent Application Publication
(10) Pub. No.: US 2015/0233030 A1
(43) Pub. Date: Aug. 20, 2015

(54) MELTBLOWN NONWOVEN FABRIC AND USES THEREOF

(71) Applicant: MITSUI CHEMICALS, INC., Minato-ku, Tokyo (JP)

(72) Inventors: Kozo Iiba, Ichihara-shi (JP); Taro Ichikawa, Sodegaura-shi (JP); Takeshi Tsuda, Sodegaura-shi (JP)

(73) Assignee: MITSUI CHEMICALS, INC., Minato-ku, Tokyo (JP)

(21) Appl. No.: 14/422,469

(22) PCT Filed: Aug. 23, 2013
(86) PCT No.: PCT/JP2013/072522

§ 371 Date: Feb. 19, 2015

(30) Foreign Application Priority Data
Aug. 23, 2012 (JP) 2012-184475

(51) Int. Cl. D04H 3/007; B01J 20/26; B01J 20/28; C09K 3/32

(52) U.S. Cl. CPC D04H 3/007; C09K 3/32; B01J 20/26; B01J 20/28038

(57) ABSTRACT

A meltblown nonwoven fabric is provided having thermoplastic resin fibers having an average fiber diameter of 0.1 to 10 μm, a bulk density of not more than 36 kg/m³ and an air permeability, as measured by a Frazier type method at basis weight of 200 g/m², of 3 to 100 cc/cm²/sec. The meltblown nonwoven fabric has a low bulk density and is excellent in sound absorption performance, oil adsorption performance, heat insulation performance, dust collection performance and filtration performance. Since the meltblown nonwoven fabric can be formed from one kind of a resin composition, it can be simply and easily produced as compared with the case of using mixed fibers or conjugated fibers formed from many kinds of resins, and the resulting meltblown nonwoven fabric can have uniformity and no variability of properties.

### TECHNICAL FIELD

The present invention relates to a meltblown nonwoven fabric having a low bulk density and air permeability. More particularly, the present invention relates to a meltblown nonwoven fabric which has a low bulk density and can be preferably used in various applications such as sound absorbing materials, oil adsorbing materials, heat insulating materials and filters.

### BACKGROUND ART

The living environment such as houses or offices or transportation means such as air planes, vehicles and automobiles demand calm environment wherein external noise is shut out, and sound absorbing materials made of foamed products containing air space, such as polyurethane foam and polyethylene foam, or fibrous products, such as felt and nonwoven fabric, have been widely used. These sound absorbing materials are properly used according to their requirements, and from the viewpoints of requirements, such as air permeability, lightweight property and economy, fibrous products such as nonwoven fabrics have been used.

Particularly for the transportation means such as automobiles, sound absorbing materials which are more lightweight and are excellent in sound absorption performance are desired. On this account, as a means to improve sound absorption performance, there has been proposed a method of using a laminate obtained by laminating another layer to a sound absorbing material, such as a method of setting a laminate of a meltblown nonwoven fabric and a needle punched nonwoven fabric in such a manner that the meltblown nonwoven fabric may be on the sound source side (patent literature 1), a method of bonding a flame-retardant meltblown nonwoven fabric sheet obtained by uniting meltblown ultrafine fibers and flame-retardant short fibers in a body, to a sheet material (patent literature 2), or a method of joining a film and a meltblown nonwoven fabric with an adhesive (patent literature 3).

In each of the above methods, however, the meltblown nonwoven fabric is used by laminating it with another material, so that problems of weight lightening and space saving are left. On this account, development of a novel nonwoven fabric improved in sound absorption effect has been desired.

### CITATION LIST

### Patent Literature

Patent literature 1: Japanese Patent Laid-Open Publication 2002-200687

Patent literature 2: Japanese Patent Laid-Open Publication 1994-212546

Patent literature 3: Japanese Patent Laid-Open Publication 2008-299703

### SUMMARY OF THE INVENTION

### Technical Problem

It is an object of the present invention to provide a novel meltblown nonwoven fabric which has a low bulk density and is preferably used as a sound absorbing material though it is lightweight.

### Solution to Problem

The meltblown nonwoven fabric of the present invention comprises thermoplastic resin fibers having an average fiber diameter of 0.1 to 10 μm,

has a bulk density of not more than 36 kg/m³, and

has an air permeability, as measured by a Frazier type method

In such a meltblown nonwoven fabric of the present invention, the thermoplastic resin fibers are preferably formed from a thermoplastic resin composition having a half-crystallization time of not more than 400 seconds.

In the meltblown nonwoven fabric of the present invention, the thermoplastic resin fibers are also preferably formed from a thermoplastic resin composition containing a crystal nucleating agent. The thermoplastic resin composition preferably contains the crystal nucleating agent in an amount of 0.01 to 10 parts by weight based on 100 parts by weight of the thermoplastic resin. The crystal nucleating agent is preferably a phosphoric acid-based nucleating agent.

In the meltblown nonwoven fabric of the present invention, the thermoplastic resin is preferably a polyolefin, and the thermoplastic resin is preferably a propylene-based polymer.

The meltblown nonwoven fabric of the present invention preferably has a thickness of 1 to 2000 mm and basis weight of 10 to 2000 g/m².

In the meltblown nonwoven fabric of the present invention, fibers other than the thermoplastic resin fibers formed by a meltblown method are preferably contained in amounts of not more than 10 parts by weight in 100 parts by weight of the meltblown nonwoven fabric.

The nonwoven fabric laminate of the present invention is obtained by laminating a spunbonded nonwoven fabric on at least one surface of the above meltblown nonwoven fabric of the present invention.

The sound absorbing material, the oil adsorbing material, the heat insulating material or the filter of the present invention comprises the meltblown nonwoven fabric of the present invention or the nonwoven fabric laminate of the present invention.

### Advantageous Effects of Invention

Since the meltblown nonwoven fabric of the present invention can be made to have a lower bulk density than other meltblown nonwoven fabrics having the same basis weight, it is excellent in sound absorption performance, oil adsorption performance, heat insulation performance and low pressure drop property, and it can be preferably used in applications such as sound absorbing materials, oil adsorbing materials, heat insulating materials and filters. Further, basis weight can be lowered while satisfactory sound absorption performance, oil adsorption performance, heat insulation performance and low pressure drop property are maintained, so that the meltblown nonwoven fabric can contribute to weight lightening and reduction of cost.

Furthermore, since the meltblown nonwoven fabric of the present invention can be preferably formed from one kind of a resin composition, it can be simply and easily produced without problems of ununiform mixing and dust as compared with the case of using mixed fibers or conjugated fibers formed from many kinds of resins, and a meltblown nonwoven fabric having uniformity and no variability of properties can be produced. Therefore, problems such as dust in use and a disadvantage in recycling can be solved.

According to the present invention, by the use of a resin composition obtained by adding a crystal nucleating agent to a crystalline thermoplastic resin, a meltblown nonwoven fabric which has a low bulk density and is excellent in properties such as sound absorption coefficient can be easily produced utilizing the existing equipment.

Since the meltblown nonwoven fabric of the present invention has a high sound absorption coefficient, even a meltblown nonwoven fabric only can be sufficiently used as a sound absorbing material, and therefore, when it is used as a sound absorbing material, weight lightening and thinning can be achieved. Also when it is laminated with another material, the resulting laminate is excellent in sound absorption performance as compared with the case of using a conventional meltblown nonwoven fabric. Therefore, the laminate is superior to other laminates having the same basis weight in sound absorption performance.

The sound absorbing material of the present invention is excellent in sound absorption performance and can be preferably used as a sound absorbing material of the living environment or the transportation means. Since the sound absorbing material, the oil adsorbing material, the heat insulating material and the filter of the present invention comprise the meltblown nonwoven fabric of the present invention, they can be obtained by a simple and easy process, and weight lightening and thinning can be achieved. Moreover, they are excellent in various performance, such as sound absorption performance, oil adsorption performance, heat insulation performance and dust collection/filtration performance.

### Description of Embodiments

The present invention is specifically described hereinafter.

A meltblown nonwoven fabric is obtained by allowing a nozzle to discharge a molten thermoplastic resin, blowing a gas to the molten resin to form fibers and colleting the fibers.

Thermoplastic Resin

The thermoplastic resin that is a raw material of the meltblown nonwoven fabric of the present invention is not specifically restricted provided that it is a thermoplastic resin capable of forming a nonwoven fabric, and publicly known various thermoplastic resins can be used. Specific examples of such thermoplastic resins include polyolefin-based polymers, e.g., polyolefins that are homopolymers or copolymers of α-olefins such as ethylene, propylene, 1-butene, 1-hexene, 4-methyl-1-pentene and 1-octene[ethylene-based polymers, e.g., homopolymers of ethylene or ethylene/α-olefin copolymers, such as high-pressure low-density polyethylene, linear low-density polyethylene (so-called LLDPE), high-density polyethylene, ethylene/propylene random copolymer and ethylene/1-butene random copolymer; propylene-based polymers, such as homopolymer of propylene (so-called polypropylene), propylene/ethylene random copolymer, propylene/ethylene/1-butene random copolymer (so-called random polypropylene), propylene block copolymer and propylene/1-butene random copolymer; 1-butene-based polymers, such as 1-butene homopolymer, 1-butene/ethylene copolymer and 1-butene/propylene copolymer; and 4-methyl-1-pentene-based polymers, such as poly-4-methyl-1-pentene homopolymer, 4-methyl-1-pentene/propylene copolymer and 4-methyl-1-pentene/α-olefin copolymer]. Further, polyesters (polyethylene terephthalate, polybutylene terephthalate, polyethylene naphthalate, etc.), polyamides (nyolon-6, nylon-66, polymetaxylene adipamide, etc.), polyvinyl chloride, polyimide, ethylene/vinyl acetate copolymer, polyacrylonitrile, polycarbonate, polystyrene, ionomer, and mixtures thereof can be given as examples.

Of these thermoplastic resins, polyolefin-based polymers are preferable from the viewpoints of spinning stability in molding process, and processability, air permeability, softness, lightweight property and heat resistance of the nonwoven fabric. Of the polyolefin-based polymers, propylene-based polymers are preferable from the viewpoints of heat resistance and lightweight property, and of the propylene-based polymers, a propylene homopolymer or a propylene/α-olefin copolymer is preferable.

Propylene-Based Polymer

The propylene-based polymer that is preferable as the thermoplastic resin in the present invention is preferably a homopolymer of propylene or a copolymer of propylene and an extremely small amount of one or more α-olefins of 2 or more carbon atoms (except propylene), preferably 2 to 8 carbon atoms, such as ethylene, 1-butene, 1-pentene, 1-hexene, 1-octene and 4-methyl-1-pentene, said homopolymer and copolymer usually having a melting point (Tm) of not lower than 125° C., preferably 130 to 165° C.

The melt flow rate (MFR: ASTM D-1238, 230° C., load of 2160 g) of the propylene-based polymer is not specifically restricted as far as the polymer is capable of being melt-spun, but it is usually in the range of 10 to 4000 g/10 min, preferably 50 to 3000 g/10 min, more preferably 100 to 2000 g/10 min.

Thermoplastic Resin Composition

The thermoplastic resin fibers to constitute the meltblown nonwoven fabric of the present invention may be formed from only the aforesaid thermoplastic resin, but they are preferably formed from a resin composition containing the thermoplastic resin and a crystal nucleating agent. In such a resin composition, the nucleating agent is contained usually in an amount of 0.01 to 10 parts by weight, preferably 0.03 to 3 parts by weight, more preferably 0.03 to 0.5 part by weight, still more preferably 0.05 to 0.3 parts by weight, based on 100 parts by weight of the thermoplastic resin.

As the crystal nucleating agent, a crystal nucleating agent capable of becoming a nucleus in the crystallization of the thermoplastic resin can be used without any restriction.

The crystal nucleating agent for use in the present invention means an additive that forms a nucleus formation site during crystallization of the thermoplastic resin when the thermoplastic resin is in a transition state from a molten state to a cooled solid structure. Such crystal nucleating agents may be used singly, or may be used in combination of two or more kinds.

In the production of the meltblown nonwoven fabric of the present invention, the thermoplastic resin or the thermoplastic resin composition in a molten state is spun by a meltblown method to obtain thermoplastic resin fibers for forming the meltblown nonwoven fabric. In the spinning of the thermoplastic resin composition containing a crystal nucleating agent, the crystal nucleating agent functions as a nucleus for crystallization when the molten thermoplastic resin composition is discharged from a nozzle and cooled. That is to say, a substance capable of becoming a crystal nucleus before crystallization of the thermoplastic resin is used as the crystal nucleating agent. On this account, the crystal nucleating agent used in the present invention may be one that is melted together with the thermoplastic resin when the thermoplastic resin is in a molten state, or may be one that is not completely melted but dispersed in the thermoplastic resin that is in a molten state.

The crystal nucleating agent preferably used in the present invention is, for example, a dibenzylidene sorbitol type compound or a phosphoric acid-based nucleating agent. Examples of the dibenzylidene sorbitol type compounds include dibenzylidene sorbitol (DBS), monomethyldibenzylidene sorbitol (e.g., 1,3:2,4-bis(p-methylbenzylidene)sorbitol (p-MDBS)) and dimethyldibenzylidene sorbitol (e.g., 1,3:2,4-bis(3,4-dimethylbenzylidene)sorbitol (3,4-DMDBS)). Further, a phosphoric acid-based nucleating agent, such as NA-11 or NA-21, sodium benzoate or the like can be also preferably used as the crystal nucleating agent. Of these, the phosphoric acid-based nucleating agent is preferable from the viewpoint of good spinning property of the meltblown nonwoven fabric.

In Japanese Patent Laid-Open Publication No. 2004-530803, polypropylene fibers produced by the use of a polypropylene resin to which a nucleating agent has been added are described, but it is only described that the shrinkage ratio is lowered in order to provide polypropylene fibers that are preferable for apparel, carpet pile, carpet backing, molded parts, etc.

In the thermoplastic resin composition for forming the thermoplastic resin fibers, publicly known various additives, such as antioxidant, weathering stabilizer, light stabilizer, anti-blocking agent, lubricant, pigment, softener, hydrophilizing agent, auxiliary, water repellent, filler and antibacterial agent, may be contained within limits not detrimental to the object of the present invention.

In the present invention, the half-crystallization time of the thermoplastic resin composition for forming the thermoplastic resin fibers is preferably not more than 400 seconds, more preferably not more than 250 seconds, still more preferably not more than 200 seconds . Although the lower limit of the half-crystallization time of the thermoplastic resin composition is not specifically restricted, it is preferably not less than 5 seconds.

In the case where the meltblown nonwoven fabric is produced using such a thermoplastic resin composition, fibers formed are crystallized for a shorter period of time when the fibers are formed by a meltblown method, as compared with the case of using a usual thermoplastic resin. Therefore, fusion bonding of the fibers is inhibited, and shifting of the nonwoven fabric to a dense structure due to fusion bonding of the fibers can be preferably prevented, whereby the resulting meltblown nonwoven fabric has an extremely low bulk density, so that use of such a thermoplastic resin composition is preferable.

Meltblown Nonwoven Fabric

The meltblown nonwoven fabric of the present invention can be obtained by spinning the above-mentioned thermoplastic resin or thermoplastic resin composition by a meltblown method and collecting thermoplastic resin fibers formed. As a meltblown spinning nozzle used for producing the meltblown nonwoven fabric of the present invention, any of nozzles used for producing publicly known meltblown nonwoven fabrics from thermoplastic resins can be used, and a nozzle pore diameter can be properly selected in consideration of the desired fiber diameter. That is to say, an apparatus equipped with a group of nozzles having pores of single pore diameter may be used, or an apparatus equipped with a group of nozzles having pores of two or more different pore diameters in a desired ratio may be used. For example, when the meltblown nonwoven fabric of the present invention is produced by the use of an apparatus having nozzles of two different pore diameters, an apparatus having a nozzle (small pore diameter-nozzle) with a nozzle pore diameter of 0.07 to 0.3 mm and a nozzle (large pore diameter-nozzle) with a nozzle pore diameter of 0.5 to 1.2 mm can be used. As the apparatus having such a group of nozzles, an apparatus wherein the pore diameter ratio of the large pore diameter-nozzle to the small pore diameter-nozzle (large pore diameter-nozzle/small pore diameter-nozzle) exceeds 2 and the ratio of the number of the small pore diameter-nozzles to the number of the large pore diameter-nozzles (small pore diameter-nozzles/large pore diameter-nozzles) is in the range of 3 to 20 can be used.

The average fiber diameter of the thermoplastic resin fibers for constituting the meltblown nonwoven fabric of thepresent invention is usually in the range of 0.1 to 10 μm, preferably 1 to 10 μm.

It is also preferable to produce the meltblown nonwoven fabric of the present invention by the use of nozzles of plural pore diameters, and therefore, it is also preferable that in a distribution of fiber diameters of the fibers to constitute the meltblown nonwoven fabric, there are two or more peaks usually in the range of 0.1 to 10 μm.

The bulk density of the meltblown nonwoven fabric of the present invention is not more than 36 kg/m³, and the lower limit thereof is not specifically restricted. However, the bulk density is preferably 5 to 36 kg/m³, more preferably 10 to 35 kg/m³.

The air permeability of the meltblown nonwoven fabric of the present invention, as measured by Frazier type method, is 3 to 100 cc/cm²/sec, preferably 3 to 50 cc/cm²/sec, more preferably 3 to 20 cc/cm²/sec.

The meltblown nonwoven fabric of thepresent invention comprises thermoplastic resin fibers. That is to say, the meltblown nonwoven fabric of the present invention is a nonwoven fabric mainly formed from fibers obtained by spinning a thermoplastic resin or a thermoplastic resin composition through a meltblown method.

The meltblown nonwoven fabric of the present invention contains, as main components, fibers formed by spinning a thermoplastic resin or a thermoplastic resin composition, preferably the aforesaid thermoplastic resin composition, through a meltblown method.

The meltblown nonwoven fabric of the present invention is particularly preferably composed of only fibers that are formed from the aforesaid thermoplastic resin composition through a meltblown method, but it may contain other fibers in such amounts that the aforesaid bulk density and air permeability are satisfied. The fibers other than the fibers formed from the thermoplastic resin composition by a meltblown method (also referred to as “other fibers” hereinafter) may be short fibers or long fibers, and may be crimped fibers or non-crimped fibers. These other fibers can be added for an arbitrary purpose, such as impartation of mechanical properties (e.g., impartation of strength), impartation of chemical properties or extending.

When the meltblown nonwoven fabric of the present invention contains, as other fibers, fibers formed by a method other than the meltblown method, such as short fibers, those fibers are preferably fibers rarely undergoing fusion bonding, and for example, fibers obtained from the aforesaid thermoplastic resin composition may be contained. Further, short fibers made of polyesters, such as polyethylene terephthalate, polybutylene terephthalate and polyethylene naphthalate, may be contained.

When the meltblown nonwoven fabric of the present invention contains other fibers, the amount of the other fibers is not specifically restricted provided that the meltblown nonwoven fabric has a bulk density and an air permeability of the aforesaid ranges, and the content of other fibers is desired to be usually not more than 20 parts by weight, preferably not more than 10 parts by weight, more preferably not more than 5 parts by weight, in 100 parts by weight of the meltblown nonwoven fabric. As the content of other fibers is decreased, the meltblown nonwoven fabric is more excellent in recycling property, low-lint property (low-fluff property) and productivity.

The basis weight (METSUKE) of the meltblown nonwoven fabric of the present invention is usually in the range of 10 to 2000 g/m², preferably 50 to 400 g/m², but it can be variously determined according to the use purpose, the scale used, etc. For example, when the meltblown nonwoven fabric of the present invention is used in the form of a single layer as a sound absorbing material, the basis weight can be set usually in the range of 30 to 1000 g/m², preferably 50 to 400 g/m². When the meltblown nonwoven fabric of the present invention is used in the form of a single layer as an oil adsorbing material, the basis weight can be set usually in the range of 30 to 1000 g/m², preferably 100 to 500 g/m². When the meltblown nonwoven fabric of the present invention is used in the form of a single layer as a heat insulating material, the basis weight can be set usually in the range of 50 to 2000 g/m², preferably 100 to 1000 g/m². When the meltblown nonwoven fabric of the present invention is used in the form of a single layer as a filter, the basis weight can be set usually in the range of 10 to 500 g/m², preferably 15 to 200 g/m².

When the meltblown nonwoven fabric of the present invention is used in the form of a nonwoven fabric laminate in which the meltblown nonwoven fabric is laminated with another layer such as the later-described spunbonded nonwoven fabric, the basis weight of the meltblown nonwoven fabric can be set usually in the range of 10 to 1000 g/m², preferably 20 to 600 g/m², more preferably 30 to 400 g/m², still more preferably 40 to 390 g/m².

The thickness of the meltblown nonwoven fabric of the present invention can be variously determined according to the use purpose. For example, when the meltblown nonwoven fabric of the present invention is used as a sound absorbing material, the thickness is usually in the range of 2 to 35 mm, more preferably 3.5 to 25 mm. A sound absorbing material having a thickness of the above range is lightweight and exhibits satisfactory sound absorption performance.

The meltblown nonwoven fabric of the present invention may be laminated with other layers within limits not detrimental to the effects of the present invention. Specific examples of other layers laminated with the meltblown nonwoven fabric of the present invention include layers of knitted fabrics, woven fabrics, nonwoven fabrics, films and paper products. For laminating (bonding) the meltblown nonwoven fabric of the present invention with other layers, publicly known various methods, e.g., thermal fusion bonding methods such as hot embossing and ultrasonic fusion bonding, mechanical entanglement methods such as needle punching and water jetting, methods using adhesives such as hot melt adhesives or urethane adhesives, and extrusion laminating, can be adopted.

The meltblown nonwoven fabric of the present invention can be preferably used in the form of a nonwoven fabric laminate in which the meltblown nonwoven fabric of the present invention is laminated with another nonwoven fabric among the above materials. As the nonwoven fabric to be laminated with the meltblown nonwoven fabric of the present invention, a meltblown nonwoven fabric other than the present invention or a spunbonded nonwoven fabric can be mentioned, and a spunbonded nonwoven fabric is more preferably used. Specifically, a nonwoven fabric laminate obtained by laminating a spunbonded nonwoven fabric on one surface or each surface of the meltblown nonwoven fabric of the present invention can be mentioned. The nonwoven fabric laminate of the present invention may have two or more layers of the meltblown nonwoven fabrics of the present invention.

The meltblown nonwoven fabric of the present invention may be subjected to secondary processing, such as gear processing, printing, coating, laminating, heat treatment and shaping, within limits not detrimental to the object of the present invention.

The meltblown nonwoven fabric of the present invention can be preferably used alone or in the form of a laminate in various applications in which meltblown nonwoven fabrics have been used, and it can be particularly preferably used in applications such as sound absorbing materials, oil adsorbing materials, heat insulating materials and filters.

Sound Absorbing Material

The sound absorbing material of the present invention comprises at least one layer of the aforesaid meltblown nonwoven fabric. The sound absorbing material of the present invention may be a sound absorbing material using a single layer of the meltblown nonwoven fabric of the present invention, or may be a sound absorbing material using two or more layers thereof laminated, or may be a sound absorbing material in which at least one layer of the meltblown nonwoven fabric of the present invention and one or more other layers are laminated in an arbitrary order. Examples of other layers include layers of a spunbonded nonwoven fabric, a meltblown nonwoven fabric other than the meltblown nonwoven fabric of the present invention and various films. The thickness and the basis weight of the sound absorbing material of the present invention can be properly selected in consideration of an object for which the sound absorbing material is used, the desired sound absorption performance, etc.

When a single layer of the meltblown nonwoven fabric of the present invention is used as the sound absorbing material of the present invention, the sound absorbing material exhibits excellent sound absorption performance of preferably absorbing sounds of high frequencies, and for example, the sound absorption coefficient at a frequency of 1000 Hz, as measured by a normal incidence method, can be increased to not less than 10%, and the sound absorption coefficient at a frequency of 5000 Hz can be increased to not less than 50%.

The sound absorbing material using the meltblown nonwoven fabric of the present invention can be preferably used for buildings or transportation means, and it can be arranged in a preferred manner against the sound source, that is, the side where a noise is generated, according to the condition of the above lamination, etc.

Oil Adsorbing Material

The oil adsorbing material of the present invention comprises the meltblown nonwoven fabric of the present invention. The oil adsorbing material of the present invention may be an oil adsorbing material using a single layer of the meltblown nonwoven fabric of the present invention, or may be an oil adsorbing material using two or more layers thereof laminated, or may be an oil adsorbing material in which at least one layer of the meltblown nonwoven fabric of the present invention and one or more other layers are laminated in an arbitrary order. The thickness and the basis weight of the oil adsorbing material of the present invention can be properly selected in consideration of the use purpose of the oil adsorbing material, the desired amount adsorbed, etc.

Such an oil adsorbing material of the present invention exhibits excellent oil adsorption performance, so that the oil adsorbing material can be used for oil recovery by adsorption or oil recovery by wiping out without any restriction, and it is preferable for treatment of contamination of seas, rivers, lakes and marshes, etc. caused by leakage or outflow of an oil or sewage or for treatment of leakage of an oil or sewage in factory, by means of adsorption recovery or wiping out. The oil adsorbing material of the present invention can be particularly preferably used for adsorption recovery of an outflow oil on a water surface. When the oil adsorbing material of the present invention is used for adsorption recovery of an outflow oil on a water surface, it is also preferable to combine the meltblown nonwoven fabric of the present invention with a material of large buoyancy by laminating or the like.

Heat Insulating Material

The heat insulating material of the present invention comprises the meltblown nonwoven fabric of the present invention. The heat insulting material of the present invention may be a heat insulating material using a single layer of the meltblown nonwoven fabric of the present invention, or may be a heat insulating material using two or more layers thereof laminated, or may be a heat insulating material in which at least one layer of the meltblown nonwoven fabric of the present invention and one or more other layers are laminated in an arbitrary order. The thickness and the basis weight of the heat insulating material of the present invention can be properly selected in consideration of the desired heat insulation performance, etc.

The heat insulating material of the present invention can be used for various buildings, transportation means, etc. without any restriction, and for example, it can be preferably used as a heat insulating material for constituting a heat insulating wall in which a heat insulating material is provided between an interior finishing material and an exterior finishing material.

Filter

The filter of the present invention comprises the meltblown nonwoven fabric of the present invention. The filter of the present invention can be used for any of a gas and a liquid, and can be preferably used as a dust collecting filter or a filtration filter.

The filter of the present invention may be a filter using a single layer of the meltblown nonwoven fabric of the present invention, or may be a filter using two or more layers thereof laminated, or may be a filter in which at least one layer of the meltblown nonwoven fabric of the present invention and one or more other layers are laminated in an arbitrary order. Examples of other layers include layers of a spunbonded nonwoven fabric, a meltblown nonwoven fabric other than the meltblown nonwoven fabric of the present invention and various films having pores.

The thickness, the basis weight, the fiber diameter, etc. of the filter of the present invention can be properly selected in consideration of the desired filer performance, etc.

### EXAMPLES

The present invention will be more specifically described on the basis of the following examples, but it should be construed that the present invention is in no way limited to those examples.

In the following examples and comparative examples, measurement and evaluation were carried out in the following manner.

(1) Basis Weight (METSUKE) (g/m²)

From a meltblown nonwoven fabric, 10 samples each having a size of 100 mm (machine direction (MD))×100 mm (cross direction (CD)) were obtained, and a mean value was calculated.

(2) Thickness (mm)

Thickness of the above sample for basis weight measurement was measured at 5 points of the center and 4 corners of the sample. A mean value of 50 samples was calculated. A thickness meter capable of applying a load of 7 g/cm² was used.

(3) Half-Crystallization Time (Second(s))

DSC measuring equipment: Perkin Elmer DSC-7

Sampling: A meltblown nonwoven fabric was subjected to hot pressing at 230° C. to prepare a thin sheet, and the thin sheet was cut into a given size and introduced into a given container.

Measuring conditions: The temperature of the sample was raised up to 230° C. at 320° C./min, and the sample was preheated for 10 minutes in an atmosphere of 230° C. Thereafter, the temperature of the sample was lowered down to 130° C. at 320° C./min, and the sample was held in an atmosphere of 130° C. A period of time required for reaching ½ of the total quantity of heat of crystallization obtained at that time was taken as a half-crystallization time.

(4) Average Fiber Diameter (μm)

A photograph of 1000 magnifications of a meltblown nonwoven fabric was taken by the use of a Hitachi electron microscope “S-3500N”, and 100 fibers were selected at random. The widths (diameters) of the fibers were measured, and an average fiber diameter in terms of a number-average fiber diameter was calculated.

(5) Bulk Density (kg/m³)

The thickness defined in the above (2) was divided by the basis weight defined in the above (1), and the resulting value was taken as a bulk density.

(6) Air Permeability (cc/cm²/sec)

At 5 points of a meltblown nonwoven fabric, the quantity of airflow at a pressure difference of 125 Pa was measured using a Frazier type testing machine in accordance with JIS L1096, and a mean value was determined.

(7) Sound Absorption Coefficient (Sound Absorption Performance)

From a meltblown nonwoven fabric, a circular specimen having a diameter of 29 mm was obtained, and a normal incident sound absorption coefficient given when a plane sound wave vertically entered the specimen was measured at a frequency of 1000 to 6400 Hz using a normal incident sound absorption coefficient measuring device (TYPE 4206 manufactured by Brüel & Kjaer) in accordance with ASTM E 1050. From the resulting sound absorption coefficient curve of 1000 to 6400 Hz, sound absorption coefficients at 1000 Hz and 5000 Hz were determined.

### Example 1

A propylene homopolymer [MFR=1550 g/10 min (measured at a temperature of 230° C. under a load of 2.16 kg in accordance with ASTM D1238), expressed by “PP” hereinafter] was used as a thermoplastic resin, and thereto was added a phosphoric acid-based nucleating agent (Nall available from Adeka Corporation, expressed by a “nucleating agent A” hereinafter) in an amount of 0.3 part by weight based on 100 parts by weight of PP to obtain a thermoplastic resin composition. Using a meltblown nonwoven fabric production apparatus equipped with meltblown spinning nozzles comprising, as a minimum repeating unit, five small pore diameter-nozzles each having a nozzle pore diameter of 0.15 mm and one large pore diameter-nozzle having a nozzle pore diameter of 0.6 mm, the thermoplastic resin composition was extruded at 300° C. and fined/solidified by means of hot air (300° C., 350 Nm³/m/hr) blown out from both sides of the spinning nozzles. Thereafter, the fibers were collected at a distance of 40 cm from the spinning nozzles to obtain a meltblown nonwoven fabric having basis weight of 200 g/m². The measurement results of the resulting meltblown nonwoven fabric are set forth in Table 1.

### Example 2

A meltblown nonwoven fabric was obtained in the same manner as described in Example 1, except that the nozzles were changed to meltblown spinning nozzles having uniform pores each having a pore diameter of 0.6 mm. The measurement results of the resulting meltblown nonwoven fabric are set forth in Table 1.

### Example 3

Using the meltblown spinning nozzles used in Example 1, a meltblown nonwoven fabric was obtained in the same manner as in Example 1, except that the amount of the nucleating agent A added was changed to 0.1 part by weight based on 100 parts by weight of PP. The measurement results of the resulting meltblown nonwoven fabric are set forth in Table 1.

### Example 4

Using the meltblown spinning nozzles used in Example 1, a meltblown nonwoven fabric was obtained in the same manner as in Example 1, except that the amount of the nucleating agent A added was changed to 0.05 part by weight based on 100 parts by weight of PP. The measurement results of the resulting meltblown nonwoven fabric are set forth in Table 1.

### Example 5

A meltblown nonwoven fabric having basis weight of 150 g/m² was obtained in the same manner as described in Example 1, except that the basis weight was changed. The measurement results of the resulting meltblown nonwoven fabric are set forth in Table 1.

### Comparative Example 1

A meltblown nonwoven fabric was obtained in the same manner as described in Example 1, except that the nucleating agent A was not added. The measurement results of the resulting meltblown nonwoven fabric are set forth in Table 1. The resulting meltblown nonwoven fabric had a high bulk density and did not exhibit good sound absorption performance.

### Comparative Example 2

A meltblown nonwoven fabric was obtained in the same manner as described in Example 2, except that the nucleating agent A was not added. The measurement results of the resulting meltblown nonwoven fabric are set forth in Table 1. The resulting meltblown nonwoven fabric had a high bulk density and did not exhibit good sound absorption performance.

### Comparative Example 3

A meltblown nonwoven fabric was obtained in the same manner as described in Example 5, except that the nucleating agent A was not added. The measurement results of the resulting meltblown nonwoven fabric are set forth in Table 1. The resulting meltblown nonwoven fabric had a high bulk density and did not exhibit good sound absorption performance.

TABLE 1

| | Ex. 1 | Ex. 2 | Ex. 3 | Ex. 4 | Ex. 5 | Comp. Ex. 1 | Comp. Ex. 2 | Comp.Ex. 3 |
|---|---|---|---|---|---|---|---|---|
| Resin species | PP | PP | PP | PP | PP | PP | PP | PP |
| Nozzles | different | uniform | different | different | different | different | uniform | different |
| | pore | pore | pore | pore | pore | pore | pore | pore |
| | diameters | diameters | diameters | diameters | diameters | diameters | diameters | diameters |
| Amount of crystal nucleating | 0.3 | 0.3 | 0.1 | 0.1 | 0.3 | none | none | none |
| agent added [part(s) by weight] | | | | | | | | |
| Bulk density [kg/m³] | 27.5 | 28.3 | 28.6 | 34.2 | 29.8 | 42.5 | 44.7 | 42.0 |
| Air permeability [cc/cm²/sec] | 14.2 | 14.1 | 16.2 | 17.8 | 11.1 | 13.4 | 25.0 | 23.4 |
| Average fiber diameter [μm] | 7.1 | 7.1 | 8.1 | 8.9 | 5.6 | 6.7 | 12.5 | 11.7 |
| Basis weight (METSUKE) [g/m²] | 207 | 192 | 192 | 195 | 146 | 203 | 201 | 149 |
| Thickness [mm] | 7.5 | 6.8 | 6.7 | 5.7 | 4.9 | 4.8 | 4.5 | 3.6 |
| Half-crystallization time [s] | 79 | 79 | 150 | 200 | 79 | 647 | 647 | 647 |
| Sound absorption coefficient | 12 | 11 | 11 | 10 | 5 | 7 | 7 | 3 |
| 1000 Hz [%] | | | | | | | | |
| Sound absorption coefficient | 81 | 79 | 65 | 61 | 51 | 49 | 44 | 33 |
| 5000 Hz [%] | | | | | | | | |

### INDUSTRIAL APPLICABILITY

The meltblown nonwoven fabric of the present invention can be used, without any restriction, in applications in which conventional meltblown nonwoven fabrics are used, and can be preferably used particularly as any of soundproofing materials or heat insulating materials of the living environment such as houses or transportation means such as automobiles, vehicles and air planes, oil adsorbing materials for adsorbing an outflow oil on a water surface, filtration filters, dust collecting filters, etc.

1. A meltblown nonwoven fabric comprising thermoplastic resin fibers with an average fiber diameter of 0.1 to 10 μm,
having a bulk density of not more than 36 kg/m³, and
having an air permeability, as measured by a Frazier type method at basis weight of 200 g/m², of 3 to 100 cc/cm²/sec.

2. The meltblown nonwoven fabric as claimed in claim 1, wherein the thermoplastic resin fibers are formed from a thermoplastic resin composition having a half-crystallization time of not more than 400 seconds.

3. The meltblown nonwoven fabric as claimed in claim 1, wherein the thermoplastic resin fibers are formed from a thermoplastic resin composition containing a crystal nucleating agent.

4. The meltblown nonwoven fabric as claimed in claim 3, wherein the thermoplastic resin composition contains the crystal nucleating agent in an amount of 0.01 to 10 parts by weight based on 100 parts by weight of the thermoplastic resin.

5. The meltblown nonwoven fabric as claimed in claim 3, wherein the crystal nucleating agent is a phosphoric acid-based nucleating agent.

6. The meltblown nonwoven fabric as claimed in claim 1, wherein the thermgplastic resin is a polyolefin.

7. The meltblown nonwoven fabric as claimed in claim 1, wherein the thermoplastic resin is a propylene-based polymer.

8. The meltblown nonwoven fabric as claimed in claim 1, which has a thickness of 1 to 2000 mm and basis weight of 10 to 2000 g/m².

9. The meltblown nonwoven fabric as claimed in claim 1, wherein fibers other than the thermoplastic resin fibers formed by a meltblown method are contained in amounts of not more than 10 parts by weight in 100 parts by weight of the meltblown nonwoven fabric.

10. A nonwoven fabric laminate obtained by laminating a spunbonded nonwoven fabric on at least one surface of the meltblown nonwoven fabric as claimed in claim 1.

11. A sound absorbing material comprising the meltblown nonwoven fabric as claimed in claim 1.

12. An oil adsorbing material comprising the meltblown nonwoven fabric as claimed in claim 1.

13. A heat insulating material comprising the meltblown nonwoven fabric as claimed in claim 1.

14. A filter comprising the meltblown nonwoven fabric as claimed in claim 1.

15. A sound absorbing material comprising the nonwoven fabric laminate as claimed in claim 10.
